(19) United States
(12) Patent Application Publication
(10) Pub. No.: US 2009/0282256 A1
(43) Pub. Date: Nov. 12, 2009

(54) SECURE PUSH MESSAGES

(75) Inventors: Milan RAKIC, Malmo (SE); Nenad PAVLOVIC, Oxie (SE)

Correspondence Address: HARRITY & HARRITY, LLP, 11350 RANDOM HILLS ROAD, SUITE 600, FAIRFAX, VA, 22030, US

(73) Assignee: Sony Ericsson Mobile Communications AB, Lund (SE)

(21) Appl. No.: 12/118,871

(22) Filed: May 12, 2008

(51) Int. Cl. G06F 21/00

(52) U.S. Cl. 713/176

(57) ABSTRACT

A device may receive a secure push message from an administrator device. In addition, the device may generate a first key by combining an administrator code, a client device identifier that identifies a client device, and subscriber information that is associated with a service to which a user subscribes. In addition, the device may hash the first key to generate a second key, and use the second key to sign a data block within the secure push message to produce an electronic signature. Further, the device may validate the secure push message based on the electronic signature.

### BACKGROUND

In wireless communications, a device may push a one-way message to a wireless device (e.g., a cell phone, a portable digital assistant, etc.) in accordance with the wireless application protocol (WAP). Under the WAP, pushing the message may involve two stages. In the first stage, the device may send the message to a push proxy gateway under the push access protocol (PAP), as specified by WAP specification 164 (WAP-164) or WAP-247. In the second stage, the push proxy gateway may relay the message to the wireless device under push over-the-air (OTA) protocol, as specified by WAP-189 or WAP-235.

### SUMMARY

According to one aspect, a method may include receiving a secure push message from an administrator device. The method may further include generating a first key by combining an administrator code, a client device identifier that identifies a client device, and subscriber information that is associated with a service to which a user subscribes. In addition, the method may include hashing the first key to generate a second key, using the second key to sign a data block within the secure push message to produce an electronic signature, and validating the secure push message based on the electronic signature.

Additionally, the method may further include obtaining, from the secure push message, parameters that are to be set within the client device.

Additionally, obtaining the parameters may include obtaining an extensible markup language data from within the secure push message.

Additionally, the method may further include comparing a nonce included in the secure push message to nonces that are stored in the client device to determine whether the secure push message is associated with a replay attack.

Additionally, receiving the secure push message may include receiving the secure push message in accordance with a wireless application protocol (WAP).

Additionally, the method may further include receiving the administrator code from the administrator device, and enabling the client device to receive secure push messages, including at least one of authenticating a personal unblocking code (PUK) or storing the administrator code in the client device when the PUK is successfully authenticated.

Additionally, authenticating the PUK may include comparing the received PUK from the administrator device to a PUK obtained from a removable memory of the client device.

Additionally, the method may further include performing a task in accordance with a command included in the secure push message.

Additionally, the method may further include sending a reply to the administrator device to indicate the task is successfully performed.

Additionally, validating the secure push message may include comparing the electronic signature to an electronic signature that is included in the secure push message.

According to another aspect, a device may include a removable memory and a processor. The removable memory may include subscriber information. The processor may be configured to receive a secure push message from a first device, and retrieve the subscriber information from the removable memory. In addition, the processor may be further configured to combine a hash of a first code associated with the first device, a client device identifier, and the subscriber information to obtain a first value. Further, the processor may be further configured to hash the first value to produce a key, use the key and a portion of the secure push message to generate an electronic signature, and authenticate the secure push message by comparing the electronic signature to an electronic signature included in the secure push message.

Additionally, the device may include a cell phone, a personal computer, or a portable digital assistant.

Additionally, the removable memory may include a subscriber information module (SIM) card.

Additionally, the processor may be further configured to send a reply to the administrator device when the secure push message is successfully authenticated.

Additionally, the reply may include a nonce that is included in the secure push message.

Additionally, the client device identifier may include an International Mobile Equipment Identity (IMEI).

Additionally, the subscriber information may include at least one of a phone number, a personal unblocking code (PUK), or an international mobile subscriber identity (IMSI).

Additionally, the processor may be further configured to compare a nonce in the secure push message to nonces that are stored in the device to determine whether the secure push message is associated with an attack.

Additionally, the secure push message may include at least one of data, an electronic signature that is created by signing a portion of the secure push message, a random number, a timestamp, or a data type value for indicating a format of data that is included in the secure push message.

According to yet another aspect, a device may include means for formatting a command and means for combining the administrator code, a client device identifier that is associated with a client device, and subscriber information that is associated with a service to which a user subscribes, to produce a first key. In addition, the device may include means for using the first key and the command to generate an electronic signature, means for combining the electronic signature and the formatted command to produce a secure push message, and means for sending the secure push message to the client device.

### BRIEF DESCRIPTION OF THE DRAWINGS

The accompanying drawings, which are incorporated in and constitute a part of this specification, illustrate one or more embodiments described herein and, together with the description, explain the embodiments. In the drawings:

FIG. 1 is a diagram of an exemplary network in which the concepts described herein may be implemented;

FIGS. 2A and 2B are front and rear views of an exemplary device of FIG. 1;

FIG. 3 is a block diagram of an exemplary device;

FIG. 4 is a functional block diagram of an exemplary client device of FIG. 1;

FIG. 5 is a functional block diagram of an exemplary administrator device of FIG. 1;

FIG. 6 is a functional block diagram of an exemplary database device of FIG. 1;

FIG. 7 is a block diagram of an exemplary database of FIG. 6;

FIG. 8 is a block diagram of an exemplary push message.

FIG. 9 is a flow diagram of an exemplary process for obtaining and storing information for creating an electronic signature;

FIG. 10 illustrates an example of the exemplary process of FIG. 9;

FIG. 11 is a flow diagram of an exemplary process for enabling a client device to receive a push message;

FIG. 12 illustrates an example for the exemplary process of FIG. 11;

FIG. 13 is a flow diagram of an exemplary process for sending a push message;

FIG. 14 is a flow diagram of an exemplary process for receiving a push message; and

FIG. 15 depicts a scenario that illustrates the exemplary processes in FIGS. 9, 11, 13, and 14.

### DETAILED DESCRIPTION

The following detailed description refers to the accompanying drawings. The same reference numbers in different drawings may identify the same or similar elements. As used herein, the term “push message” may refer to a message that is sent from a device that initiates, for the purpose of sending the message, communication between the device and one or more other devices. In addition, the terms “administrator code,” to be described below, and “hash of administrator code” may be interchangeably used whenever appropriate. For example, a device that may send an administrator code may also send a hash of the administrator code.

### Overview

In the following, a sender may send a secure push message to a client device. For security of the client device, the secure push message may bear an electronic signature, which may validate (e.g., authenticate) the secure push message at the client device.

Before sending the secure push message, the sender may produce the electronic signature by signing a message with a key. The message may include a substantive portion (e.g., payload) of the secure push message. The key may include codes that may be used, by the client device, to validate the secure push message.

For the client device, using the codes to validate the secure push message may protect the client device in a number of ways. For example, using the codes, the client device may authenticate the sender. In another example, using the codes may verify that an intended recipient of the secure push message is the client device, and that the client device includes a correct component. For instance, using the codes may verify that the secure push message is intended for a device that includes a specific Subscriber Identity Module (SIM) card.

In the above, for the client device, using the codes in the electronic signature of the secure push message may validate the secure push message in a number of ways. In this manner, the secure push message may provide a high level of security. The format of the secure push message may be simple and flexible, and may be easily modified to accommodate different types of applications/devices that receive/send secure push messages.

### Exemplary Network and Devices

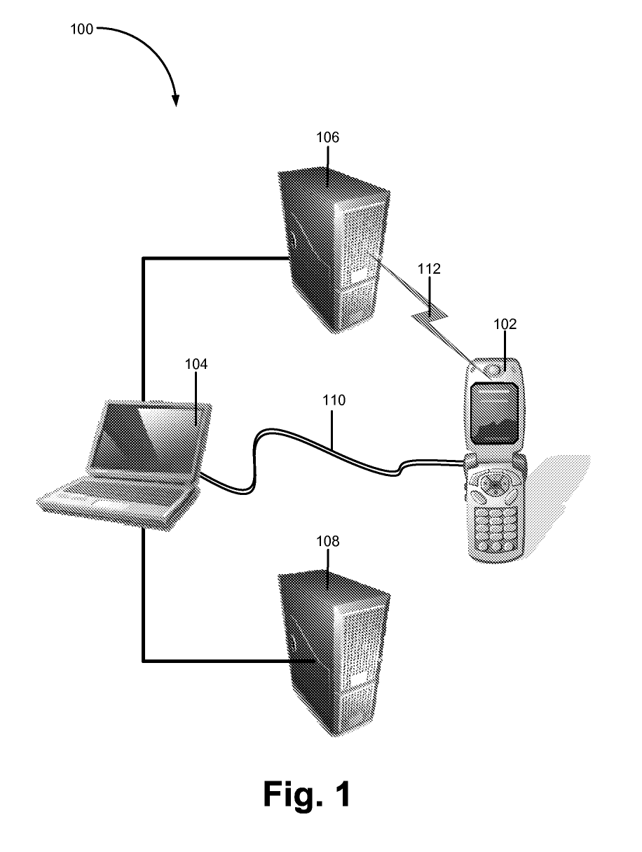

FIG. 1 illustrates the concepts described herein. As shown, network 100 may include a client device 102, an administrator device 104, a gateway 106, and a database device 108. Depending on the implementation, network 100 may include additional, fewer, or different devices than those illustrated in FIG. 1. For example, network 100 may include multiple client devices 102.

Device 102 may include any of the following devices that have the ability to or are adapted to communicate and interact with another device, such as a radiotelephone or a mobile telephone with ultra wide band or Bluetooth communication capability; a personal communications system (PCS) terminal that may combine a cellular radiotelephone with data processing, facsimile, and/or data communications capabilities; an electronic notepad, a laptop, and/or a personal computer that communicate with wireless peripherals (e.g., a wireless keyboard, speakers, etc.); a personal digital assistant (PDA) that can include a telephone; a Global Positioning System device and/or another type of positioning device; a gaming device or console; a peripheral (e.g., wireless headphone); a digital camera; or another type of computational or communication device.

Administrator device 104 may include any device that may be used to administer and/or control client device 102. Examples of administrator device 104 include a server, a personal computer, a laptop, and/or any other type of device with sufficient memory, processing speed, and/or bandwidth to administer/control one or more client devices 102.

Gateway 106 may include a device via which client device 102 may communicate with devices in network 100. In one implementation, gateway 106 may receive push messages from administrator device 104 in accordance with the push access protocol, as specified by wireless application protocol (WAP) specification 164 (WAP-164) or WAP-247. In addition, gateway 106 may send the push messages from administrator device 104 to client device 102 in accordance with push over-the-air (OTA) protocol, as specified by WAP specification 189 (WAP-189) or WAP-235.

Database device 108 may include a database of information about client device 102. In some implementations, the database may be included in administrator device 104, and in such instances, network 100 may not include a separate database device 108.

In the above, administrator device 104 may configure client device 102 via a cable 110. Alternatively, administrator device 104 may configure client device 102 via wireless communications. During the configuration, administrator device 104 may obtain information that is specific to client device 102, store the information in a database on database device 108, and store an administrator code in client device 102.

Once client device 102 is configured, administrator device 104 may retrieve the information related to client device 102 from database device 108, generate an electronic signature by signing a message based on the information, and combine the message with the electronic signature to produce a secure push message. Subsequently, administrator device 104 may send the secure push message to client device 102.

When client device 102 receives the secure push message, client device 102 may validate the secure push message based on the electronic signature. If client device 102 is able to validate the secure push message, client device 102 may send a response to administrator device 104 to indicate that client device 102 has successfully received and/or validated the secure push message.

Depending on the implementation, client device 102 may perform a specific task in accordance with contents of the secure push message. For example, client device 102 may set parameters that are related to an application in client device 102, update firmware, reset parameters that are associated with subscription services, set security parameters, etc.

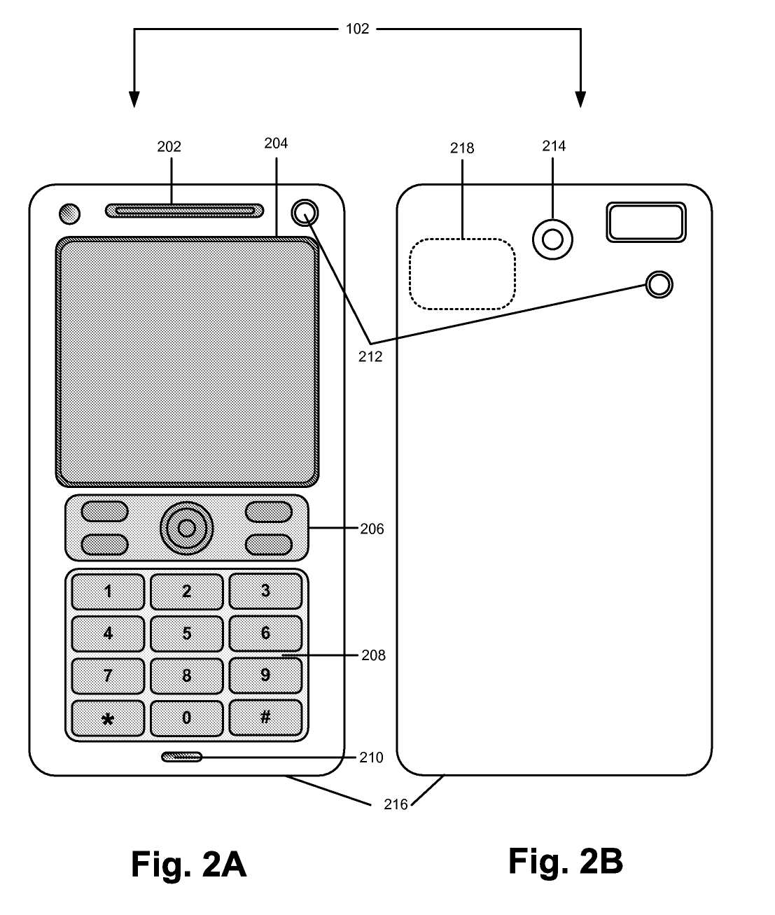

FIGS. 2A and 2B are front and rear views, respectively, of client device 102. In this implementation, client device 102 may take the form of a portable phone (e.g., a cell phone). As shown in FIGS. 2A and 2B, device 102 may include a speaker 202, a display 204, control buttons 206, a keypad 208, a microphone 210, sensors 212, a lens assembly 214, housing 216, and a removable memory 218 (e.g., a SIM card). Speaker 202 may provide audible information to a user of client device 102. Display 204 may provide visual information to the user, such as an image of a caller, video images, or pictures. Control buttons 206 may permit the user to interact with client device 102 to cause client device 102 to perform one or more operations, such as place or receive a telephone call. Keypad 208 may include a standard telephone keypad. Microphone 210 may receive audible information from the user. Sensors 212 may collect and provide, to client device 102, information (e.g., acoustic, infrared, etc.) that is used to aid the user in capturing images. Lens assembly 214 may include a device for manipulating light rays from a given or a selected range, so that images in the range can be captured in a desired manner. Housing 216 may provide a casing for components of client device 102 and may protect the components from outside elements.

Removable memory 218 may store information that is associated with a user (e.g., a service subscriber). The information (e.g., an International Mobile Subscriber Identity (IMSI) code, a phone number, a personal unblocking key (PUK), etc.) in removable memory 218 may be used to identify the user and/or a service to which the user subscribes. In one implementation, a user may exchange client device 102 with another device without changing the subscription, by transferring removable memory 218 from client device 102 to the other device.

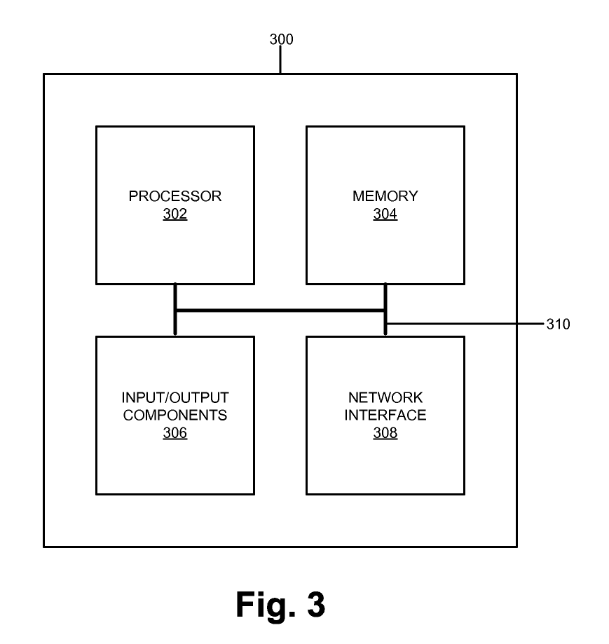

FIG. 3 is a block diagram of a device 300, which may correspond to client device 102, administrator device 104, gateway 106, or database device 108. As shown, device 300 may include a processor 302, a memory 304, input/output components 306, a network interface 308, and a communication path 310. In different implementations, device 300 may include additional, fewer, or different components than the ones illustrated in FIG. 3. For example, device 300 may include additional network interfaces, such as interfaces for receiving and sending packets.

Processor 302 may include a processor, a microprocessor, an Application Specific Integrated Circuit (ASIC), a Field Programmable Gate Array (FPGA), and/or other processing logic capable of controlling device 300. Memory 304 may include static memory, such as read only memory (ROM), and/or dynamic memory, such as random access memory (RAM), or onboard cache, for storing data and machine-readable instructions. Memory 304 may also include storage devices, such as a floppy disk, CD ROM, CD read/write (R/W) disc, and/or flash memory, as well as other types of storage devices.

Input/output components 306 may include a display screen, a keyboard, a mouse, a speaker, a microphone, a Digital Video Disk (DVD) writer, a DVD reader, Universal Serial Bus (USB) lines, and/or other types of components for converting physical events or phenomena to and/or from digital signals that pertain to device 300.

Network interface 308 may include any transceiver-like mechanism that enables device 300 to communicate with other devices and/or systems. For example, network interface 308 may include mechanisms for communicating via a network, such as the Internet, a terrestrial wireless network (e.g., a WLAN), a satellite-based network, a WPAN, etc. Additionally or alternatively, network interface 308 may include a modem, an Ethernet interface to a LAN, and/or an interface/connection for connecting device 300 to other devices (e.g., a Bluetooth interface).

Communication path 310 may provide an interface through which components of device 300 can communicate with one another.

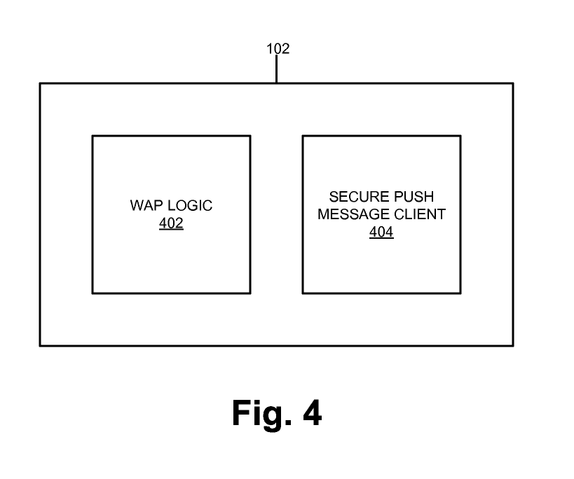

FIG. 4 is a functional block diagram of client device 102. As shown, client device 102 may include WAP logic 402 and a secure push message client 404. Although not illustrated in FIG. 4, client device 102 may include additional functional components, such as the components that are shown in FIG. 3, an operating system (e.g., Symbian OS, Palm OS, Windows Mobile OS, Blackberry OS, etc.), an application (e.g., an instant messenger client, an email client, etc.), logic for wireless or wire-line communication protocols other than the WAP, etc.

WAP logic 402 may process messages that are sent or received over wireless communication links in accordance with the WAP. For example, when client device 102 and gateway 106 communicate wirelessly, client device 102 and gateway 106 may exchange messages in accordance with WAP-164 or WAP-247.

Secure push message client 404 may validate secure push messages that are received from administrator device 104. When secure push message client 404 validates a secure push message, secure push message client 404 may perform a set of tasks that are associated with the secure push message (e.g., set security parameters in client device 102) and send a response to administrator device 106, to indicate that client device 102 has validated the secure push message.

In some implementations, secure push message client 404 may provide application/user interfaces to receive, store, and/or retrieve information that is related to processing secure push messages. For example, when administrator device 104 requests client device 102 to provide a client device identifier (e.g., International Mobile Equipment Identity (IMEI)), secure push message client 404 may provide the client device identifier to administrator device 104. In another example, secure push message client 404 may store codes that are sent by administrator device 104 in a secure location within client device 102.

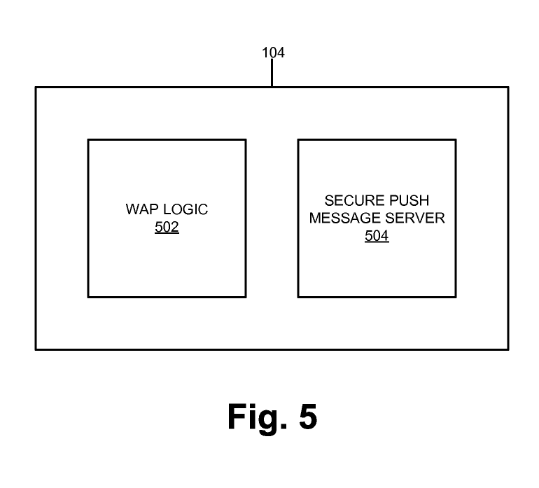

FIG. 5 is a functional block diagram of administrator device 104. As shown, administrator device 104 may include WAP logic 502 and a secure push message server 504. Although not illustrated in FIG. 5, administrator device 104 may include additional functional components, such as the components that are shown in FIG. 3, an operating system (e.g., Windows, Linux, Mac OS™, etc.), an application (e.g., an email server, an file transfer protocol (FTP) server, etc.), a database, logic for wireless or wire-line communication protocols other than the WAP, etc.

WAP logic 502 may process messages that are sent or received over wireless communication links in accordance with the WAP. For example, when administrator device 104 and gateway 106 communicate through a wire-line network, administrator device 104 and gateway 106 may exchange messages in accordance with WAP-189 or WAP-235.

Secure push message server 504 may send secure push messages to client device 102 via a wireless network or gateway 106. Given a message or a payload from an application, a user, or an administrator, secure push message server 504 may generate a key, an electronic signature, and a secure push message.

Secure push message server 504 may generate the key based on codes (e.g., IMEI) that are obtained from client device 102, a component in client device 102 (e.g., removable memory 218), and an administrator. Depending on the implementation, additional codes or information may be used to generate the key. Once the key is generated, secure push message server 504 may generate an electronic signature based on the key and the message.

In possession of the electronic signature and the key, secure push message server 504 may generate and send the secure push message to client device 102. In one implementation, secure push message server 504 may generate the secure push message by appending the electronic signature to the message and/or other information (e.g., a timestamp).

In addition to generating/sending secure push messages to client device 102, secure push message server 504 may obtain and store information that is needed to generate the key. In one implementation, while configuring client device 102, secure push message server 504 may obtain a client device identifier from client device 102, subscriber information from removable memory 218 that is not yet installed in client device 102, and an administrator code from an administrator. Furthermore, secure push message server 504 may store the client device identifier, the information, and the administrator code in a database.

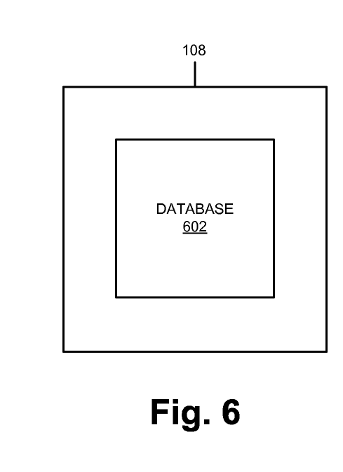

FIG. 6 is a functional block diagram of database device 108. As shown, database device 108 may include a database 602 for storing information that may be used to create keys for generating electronic signatures. In a different implementation, database 602 may be included in administrator device 104. In addition, although not illustrated in FIG. 6, database device 108 may include additional functional components, such as the components that are shown in FIG. 3, an operating system (e.g., Windows, Linux, etc.), an application, etc.

Database 602 may include information that is associated creating electronic signatures. When administrator device 104 obtains information and/or codes that are used for creating an electronic signature or a key, administrator device 104 may store the information/codes in database 602. Conversely, administrator device 104 may retrieve the information/codes from database 602, for example, to generate a secure push message or to send a code to client device 102.

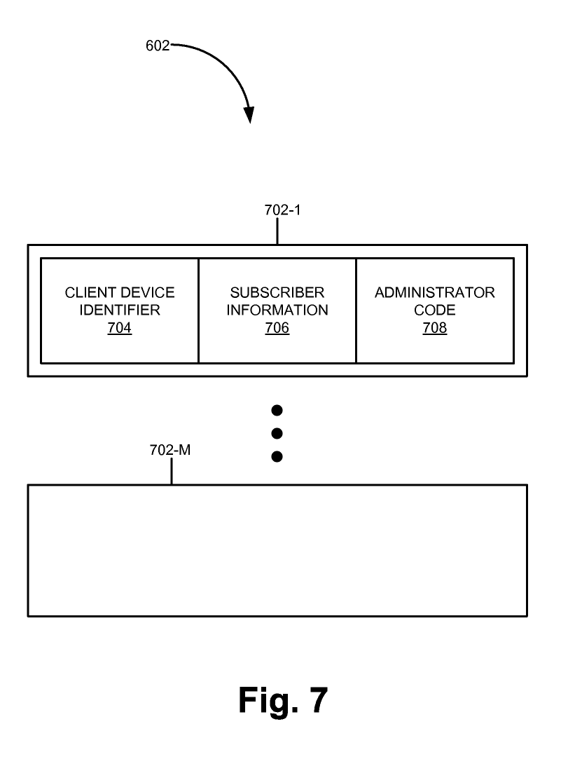

FIG. 7 is a block diagram of database 602. As shown in FIG. 7, database 602 may include records 702-1 through 702-M (hereinafter collectively referred to as records 702 and individually as record 702-x). As further shown, each record 702-x may include a client device identifier field 704, subscriber information field 706, and administrator code field 708. Depending on the implementation, record 702-x may include additional, fewer, or different fields than those illustrated in FIG. 7.

Client device identifier field 704 may include an identifier that is associated with a client device (e.g., IMEI). Subscriber information field 706 may include subscriber information, such as an IMSI code, phone number, a PUK, etc. In one implementation, administrator device 104 may obtain the subscriber information from a component of client device 102 (e.g., SIM card) and store the subscriber information in record 702-x. Administrator code field 708 may include a code that is provided by an administrator or a hash of the administrator code. When the administrator changes the code for security purposes, administrator code field 708 may be updated to reflect the change.

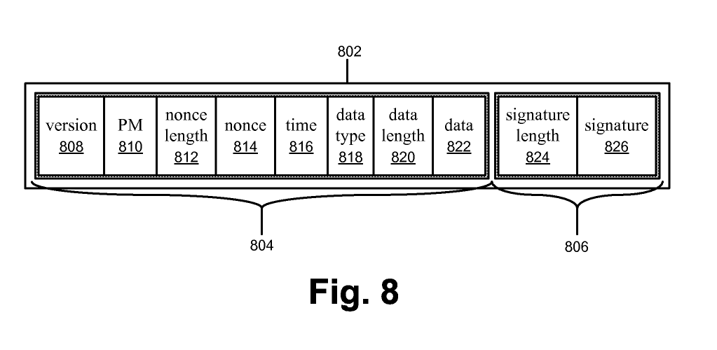

FIG. 8 is a block diagram of an exemplary secure push message 802. As shown, secure push message 802 may include a data block 804 and a signature block 806. Data block 804 may include fields that are related to content. Signature block 806 may include fields for an electronic signature for data block 804.

As further shown, data block 804 may include a version field 808, a protection mechanism (PM) field 810, a nonce length field 812, a nonce field 814, a time field 816, a data type field 818, a data length field 820, and a data field 822. Signature block 806 may include a signature length field 824 and a signature field 826.

Version field 808 may include a version number that is associated with a specific format of secure push message 802 (e.g., version 1, version 2, etc.). PM field 810 may indicate a particular method that is used to generate a signature, to encrypt the data, or to perform a combination of generating a signature and encrypting the data. Nonce length field 812 may indicate the length of nonce field 814. Nonce field 814 may include a nonce (e.g., a random number). Time field 816 may include the time when secure push message 802 is created at administrator device 104.

Data type field 818 may indicate the format of data in data field 822, as explained below. For example, in one implementation, if data type field 818 includes XML_DATA_TYPE, data field 822 may carry eXtensible Markup Language (XML) data. In such a case, the XML data may be canonicalized (e.g., standardize XML representation), such that an electronic signature resulting from signing the XML data may be unique.

The relationship between data type field 818 and data field 822 may be summarized by the following expression.

| If (DATA_TYPE = “XML_DATA_TYPE”) | |
|---|---|
| DATA = C14N(XML_Data) | |
| else | |
| DATA = RAW_Data | (1). |

In expression (1), DATA_TYPE may represent contents of data type field 818, DATA may represent contents of data field 822, C14N(XML_Data) may represent canonicalization (e.g., normalization) of XML_Data (e.g., data in XML format). RAW_Data may represent other types of data, such as binary data, text data, hypertext markup language (HTML) data, etc.

Data length field 820 may include a length of data field 822. Data field 822 may include content (e.g., payload).

Signature length field 824 may indicate the length of signature field 826. Signature field 824 may include an electronic signature of data block 804. In one implementation, signature field 826 may include a value provided by the following expression.

SIG=S(DATA_BLOCK, KEY) (2).

In expression (2), SIG may represent contents of signature field 826, DATA_BLOCK may represent contents of data block 804, KEY may represent a key that may be constructed based on information in record 702-x, and S(DATA_BLOCK, KEY) may represent signing DATA_BLOCK based on KEY.

In one implementation, KEY in expression (2) may be generated by appending IMSI, IMEI, and an administrator code to produce a raw key, and then hashing the raw key. In such an instance, the relationship between KEY, IMSI, IMEI, and the administrator code may be provided as follows.

KEY=H(IMSI∥IMEI∥ADMIN_CODE) (3).

In expression (3), KEY may be KEY in expression (2), ADMIN_CODE may represent contents of administrator code field 708. IMSI∥IMEI∥ADMIN_CODE may represent the raw key that is formed by combining IMSI, IMEI, and ADMIN_CODE in accordance with a particular mathematical operation. For example, in one implementation, the raw key may be formed by concatenating IMSI, IMEI, and ADMIN_CODE. H(IMSI∥IMEI∥ADMIN_CODE) may represent a hash of IMSI∥IMEI∥ADMIN_CODE.

Even though FIG. 8 shows fields 808-826 as being arranged in a specific sequence, in different implementations, fields 808-826 may be arranged in a different order. Furthermore, depending on the implementation, secure push message 802 may include fewer, additional, or different fields than those illustrated in FIG. 8.

### Exemplary Processes for Configuring Devices to Send/Receive a Secure Push Message

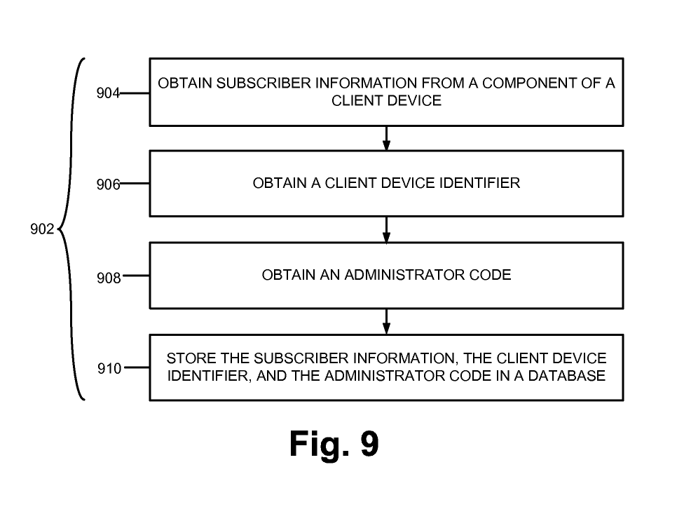

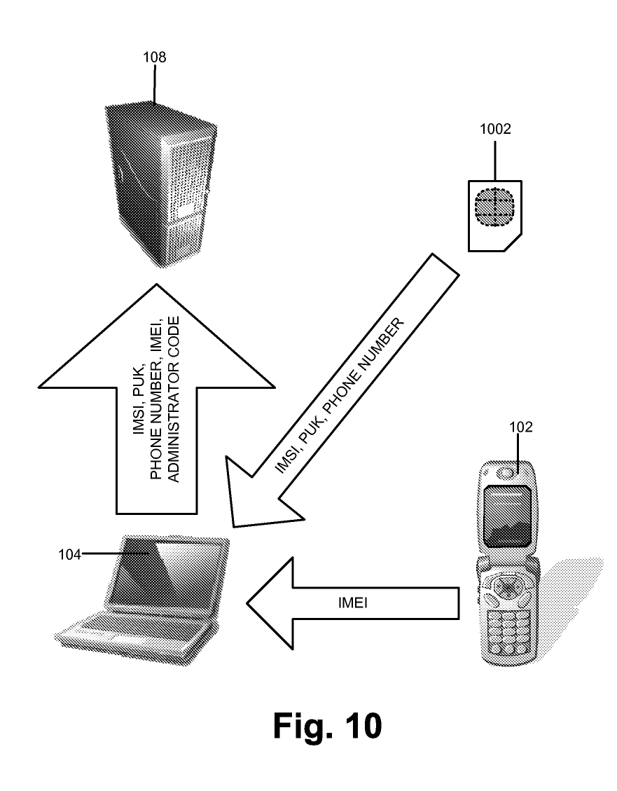

FIG. 9 is flow diagram of an exemplary process 902 for obtaining and storing information that may be used to generate an electronic signature of the secure push message in a database, and FIG. 10 illustrates an example associated with process 902. Assume that an administrator is in physical possession of and/or in contact with client device 102 and a component. The component (e.g., SIM card 1002), which may include subscriber information, may or may not be installed in client device 102.

Process 902 may start at block 904, where subscriber information from a component of client device 102 may be obtained (block 904). FIG. 10 illustrates obtaining the subscriber information. As shown in FIG. 10, administrator device 104 may obtain the subscriber information (e.g., PUK, IMSI, phone number, etc.) from a SIM card 1002. In one implementation, administrator device 104 may receive the subscriber information via a user interface from an administrator.

A client device identifier may be obtained (block 906). As shown in FIG. 10, administrator device 104 may obtain an IMEI from client device 102.

An administrator code may be obtained (block 908). For example, secure push message server 504 may receive, via a user interface, the administrator code from an administrator. In a different implementation, push message server 504 may automatically generate the administrator code.

The subscriber information, the client device identifier, and the administrator code may be stored in a database (block 910). For example, as illustrated in FIG. 10, administrator device 104 may store the subscriber information (e.g., IMSI, PUK, the phone number, etc.), the IMEI, and the administrator code in database 602 hosted on database device 108. In a different implementation, administrator device 104 may store the subscriber information, the IMEI, and the administrator code in a database that is hosted on administrator device 104.

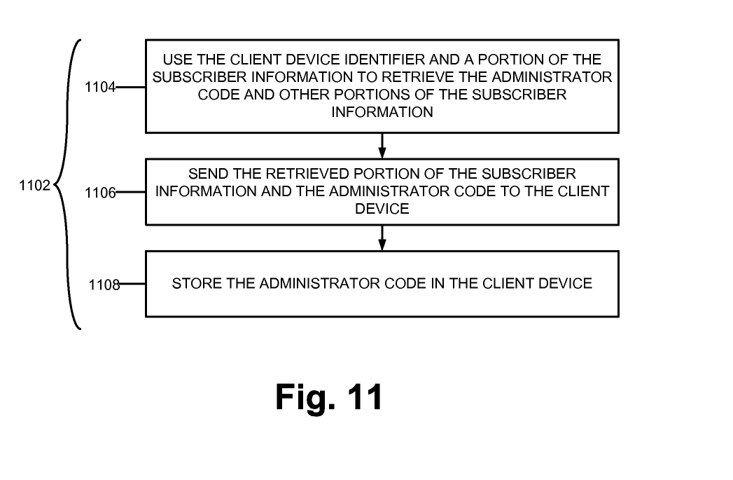

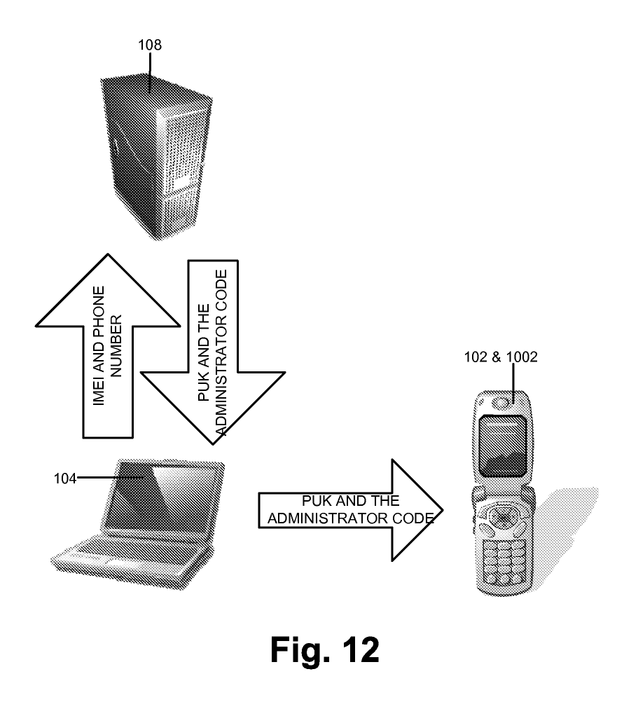

FIG. 11 is a flow diagram of an exemplary process 1102 for enabling a client device to receive a push message, and FIG. 12 illustrates an example associated with process 1102. Assume that a component from which the subscribed information is obtained in process 902 is installed in client device 102 (e.g., SIM card 1002 is installed in client device 102). Client device 102 and administrator device 104 may communicate with one another via a wireless or wired communication link.

Process 1102 may begin at block 1104, where the client device identifier and a portion of the subscriber information may be used to retrieve the administrator code and other portions of the subscriber information (block 1104). For example, as shown in FIG. 12, administrator device 104 may send a database query that includes the portion of the subscriber information (e.g., phone number) and the client device identifier (e.g., IMEI), IMSI, etc. As further shown, administrator device 104 may receive other portions of the subscriber information (e.g., PUK) and the administrator code from database device 108 in response to the query.

The retrieved portion of the subscriber information and the administrator code may be sent to client device 102 (block 1106). As shown in FIG. 12, administrator device 104 may send the PUK and the administrator code to client device 102.

The administrator code may be stored in client device 102 (block 1108). In some implementations, when client device 102 receives the retrieved portion of the subscriber information (e.g., PUK), client device 102 may compare the received portion to a portion of the subscriber information that is obtained within the installed component (e.g., SIM card 1002 that is installed in client device 102). If the received portion matches the portion obtained from the installed component, client device 102 may store the administrator code in a secure memory location within client device 102. In one implementation, the memory location may not be accessible to the subscriber. Because the administrator code at the memory location is also inaccessible to the subscriber, the subscriber may not be able to modify the administrator code to prevent client device 102 from performing tasks in accordance with a secure push message that is received at client device 102, unless the subscriber turns off client device 102.

In processes 902 and 1102, only client device 102, administrator device 104, and/or database device 108 may have access to the client device identifier, the subscriber information, and the administrator code. Furthermore, the administrator may change (e.g., replace) the administrator code in client device 102 at a convenient time (e.g., when client device 102 can be reached via a wireless communication link) in accordance with process 1102.

### Exemplary Process for Sending a Push Message

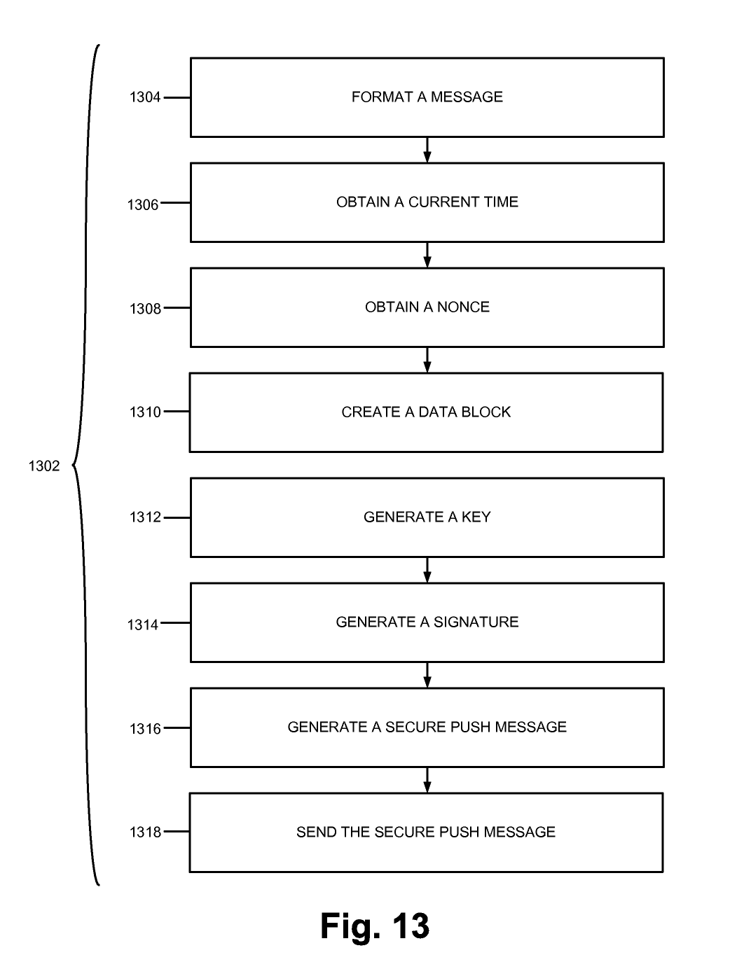

FIG. 13 is a flow diagram of an exemplary process 1302 for sending a push message. Assume that administrator device 104 communicates with client device 102 via a wireless or wired communication link. Process 1302 may begin at block 1304, where a message (e.g., a command for client device 102) may be formatted.

In some implementations, secure push message server 504 may format the message in accordance with a preset formatting scheme or a formatting scheme that is selected by the administrator. For example, the message may be formatted in accordance with the HTML or XML syntax, depending on the specific implementation details of secure push message server 504 and/or secure push message client 404.

If the message is formatted in accordance with the XML syntax, the formatted message may be canonicalized (e.g., normalized). By canonicalizing the formatted data, secure push message server 504 may ensure that the message is uniquely represented, and that a unique electronic signature can be created for the formatted data.

In one implementation, the canonical form of the XML formatted message may be expressed as follows.

| <command> | |
|---|---|
| <name/> | |
| <data/> | |
| </command> | (4). |

In expression (4), <name/> and <data/> may provide a name-value pair. For example, assume that the XML-formatted message includes a domain name of an incoming email server, which is “pop3.talktome.com.” The XML-formatted message may take the following form.

| <command> | |
|---|---|
| <name> set incoming mail server domain name </name> | |
| <data> pop3.talktome.com </data> | |
| </command> | (5) |

When secure push message client 404 receives a valid, secure push message that includes expression (5), secure push message client 404 may set the name of incoming mail server's domain name within client device 102 to pop3.talktome.com.

In general, an XML-formatted message may include one or more <name/> and <data/> pairs. Furthermore, a specific action that secure push message client 404 may take in response to receiving the <name/> and <data/> pair may depend on implementation details that are associated with secure push message client 404 and secure push message server 504.

In some instances, administrator device 104 may not format the message, and therefore, avoid memory intensive or processing intensive operations that are associated with formatting data. In such instances, data type field 818 may be set to RAW_Data, as shown in expression (1).

The time may be obtained (block 1306). For example, secure push message server 504 may request the current time from an operating system of administrator device 104. Assume that the time is “1208439990.” The value “1208439990” may represent the number of seconds since midnight Coordinated Universal Time (UTC) of Jan. 1, 1970. In this case, 1208439990 seconds after Jan. 1, 1970 may be equivalent to Apr. 17, 2008 at 1:46:30 p.m.

A nonce may be obtained (block 1308). For example, secure push message server 504 may obtain the nonce by, for example, invoking a pseudorandom number generator.

Data block 804 may be created (block 1310). For example, secure push message server 504 may create data block 804 by obtaining and combining values for version field 808, PM field 810, nonce length field 812, nonce field 814, time field 816, data type field 818, data length field 820, and data field 822.

The values for version number field 808 and PM field 810 may be preset within secure push message server 504. The value for nonce length field 812 may be predetermined (e.g., 20 bytes), or alternatively, may be obtained by counting the number of bytes that are required to represent the nonce obtained at block 1308. Time field 816 may bear the date obtained at block 1306.

Data type field 818 may be obtained in accordance with a specific formatting scheme that is used to format the message at block 1304. For example, if the message is formatted as an XML message, data type field 818 may include XML_DATA_TYPE. Data length 820 may include the number of bytes in data field 822. Data field 822 may include the formatted data.

A key may be generated (block 1312). In one implementation, secure push message server 504 in administrator device 104 may use the client device identifier and/or a portion of the subscriber information (e.g., phone number) to perform a database lookup of other portions of the subscriber information (e.g., IMSI, PUK, etc.) and the administrator code.

When secure push message server 504 receives the other portions of the subscriber information, the client device identifier, and the administrator code from the database, secure push message server 504 may generate a key. In one implementation, secure push message server 504 may generate the key based on expression (3), by combining IMSI, IMEI, and the administrator code, and hashing the result of the combination.

A signature may be generated (block 1314). For example, secure push message server 504 may generate the signature in accordance with expression (2), by signing data block 804 with the key generated at block 1312.

A secure push message may be generated (block 1316). In one implementation, secure push message server 504 may obtain the length of signature field 826 (i.e., value from field 824), and may append the signature generated at block 1314 to the length to obtain signature block 806. Furthermore, secure push message server 504 may append signature block 806 to data block 804 that is generated at block 1310, to produce the secure push message.

The secure push message may be sent (block 1318). In some implementations, secure push message 504 may send the secure push message in accordance with a particular communication protocol. In sending the secure push message, the original message (e.g., expression (5)) in data field 822 of data block 804 of the secure push message may not need to be authenticated, as a valid electronic signature in signature block 806 may guarantee the integrity of the entire secure push message.

### Exemplary Process for Receiving a Push Message

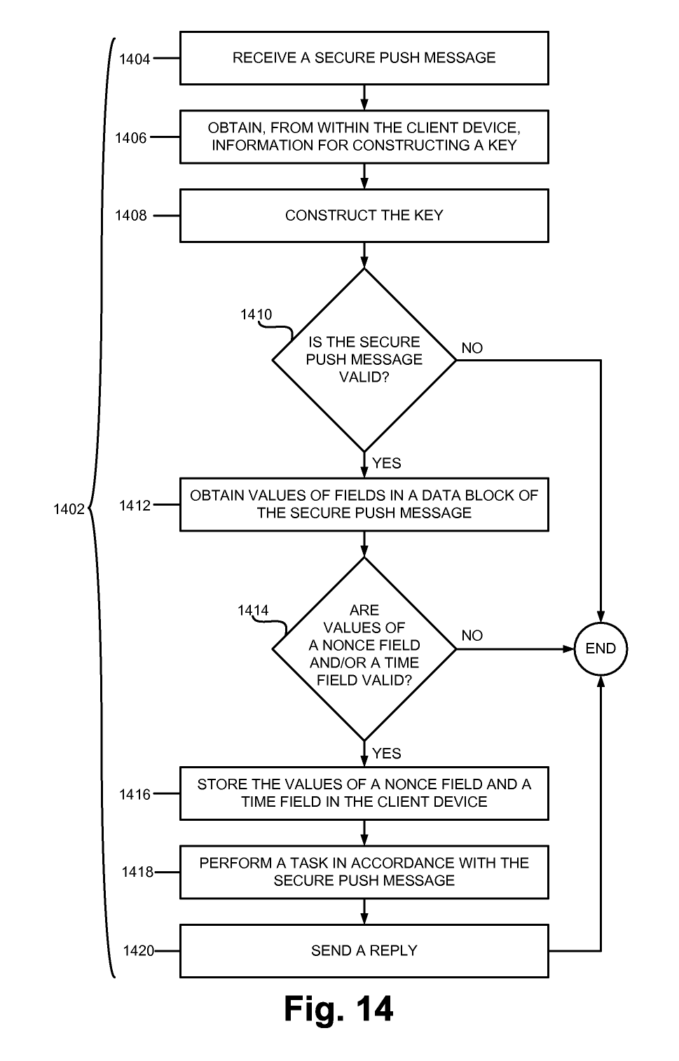

FIG. 14 is a flow diagram of an exemplary process 1402 for sending a secure push message. Assume that an administrator has configured client device 102 in accordance with process 902, and that administrator device 104 has created and sent a secure push message to client device 102. In one implementation, the secure push message may have been sent in accordance with a WAP.

Process 1402 may begin at 1404, where the secure push message may be received (block 1404). For example, client device 102 may receive a secure push message that is sent from administrator device 104 at block 1318.

Information for constructing a key may be obtained from within client device 102 (block 1406). In one implementation, secure push message client 404 may retrieve the administrator code, which has been stored in client device 102 at block 1108 (FIG. 11), an IMEI (e.g., a client device identifier) of client device 102, and the subscriber information from a component (e.g., SIM card 218 or 1002) within client device 102.

The key may be constructed (block 1408). In some implementations, secure push message client 404 may construct the key by combining the administrator code, the subscriber information, and the client identifier. In one implementation, secure push message client 404 may construct the key in accordance with expression (3).

It may be determined whether the secure push message is valid (block 1410). For example, to validate the secure push message, secure push message client 404 may obtain data block 804 and signature block 806 from the secure push message that is received at block 1404, sign obtained data block 804 based on the key constructed at block 1408, and compare the value of signature field 826 in signature block 804 to the signed data block 804. If the signed data block 804 is identical to the value of signature field 826, secure push message client 404 may determine that the secure push message is valid. Otherwise, secure push message client 404 may determine that the secure push message is invalid.

In the preceding, because the key is constructed based on information that could have been obtained only through a physical contact with client device 102 (e.g., the administrator code, IMSI, IMEI, etc.), validating the secure push message may indicate the authenticity of the sender.

At block 1410, if the secure push message is determined as a valid message, process 1402 may proceed to block 1412. Otherwise, process 1402 may terminate.

Values of fields 808-822 in data block 804 of the secure push message may be obtained (block 1412). In one implementation, secure push message client 404 may obtain each of the values in version field 808, PM field 810, nonce length field 812, nonce field 814, time field 816, data type field 818, data length field 820, and data field 822 from data block 804 in the secure push message.

It may be determined whether the values of nonce field 814 and time field 816 are valid (block 1414). For example, secure push message client 404 may compare the nonce and the timestamp in nonce field 814 and the time field 816 to values of previous nonce field/time field values that are stored in client device 102. If the nonce and the timestamp matches any of the previous nonce field/time field values, the nonce and the timestamp may be determined as being invalid. That is, the same nonce and/or timestamp may indicate that the message is a duplicate message. By checking the nonce and the timestamp, secure push message client 404 may protect client device 102 against replay attacks or other types of attacks.

If the value of nonce field 814 and/or time field 816 is valid, process 1402 may proceed to block 1416. Otherwise, process 1402 may terminate.

At block 1416, the values of nonce field 814 and time field 816 may be stored in client device 102 (block 1416). Secure push message client 404 may later use the stored values to determine the validity of nonces/timestamps when client device 102 receives secure push messages.

A task may be performed in accordance with the secure push message (block 1418). In one implementation, based on the value of data field 822, secure push message client 404 may perform a specific task. For instance, assume that the value of data type field 818 is XML_DATA_TYPE, and that the value of data field 822 is obtained from expression (5) illustrated above. Based on the values “set incoming mail server domain name” and “pop3.talktome.com” within <name/> and <data/> tags, secure push message client 404 may set the domain name of incoming mail server to pop3.talktome.com.

In some instances, the data in data field 822 may include raw data. In such instances, secure push message client 404 may avoid memory intensive or processing intensive operations that are associated with scanning formatted data.

A reply may be sent (block 1420). In one example, secure push message client 404 may send the value of nonce field 814 and a status code (e.g., a code to indicate whether the task has been successfully complete, whether the secure push message is valid, etc.) to administrator device 104.

### EXAMPLE

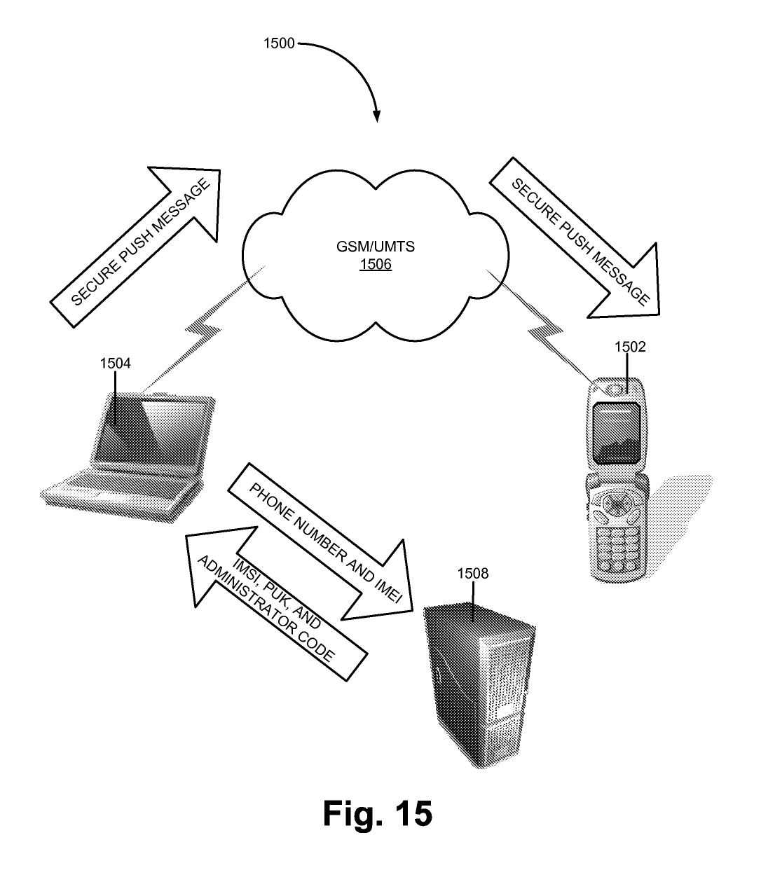

The following example, with reference to FIG. 15, illustrates above described processes 902, 1102, 1302, and 1402. In the example, assume that Bill configures a laptop 1504 (an administrator device 104), configures John's cell phone 1502 (a client device 102), and sends a secure push message from laptop 1504 to cell phone 1502 Global System for Mobile communications (GSM)/Universal Mobile Telecommunications systems (UMTS). Cell phone 1502 receives the secure push message and performs a task.

In the example, also assume that, initially, Bill has cell phone 1502, a SIM card for cell phone 1502, and laptop 1504 in his possession, and chooses “Johnphone” as an administrator code. Assume that the SIM card is not installed in cell phone 1502.

Bill obtains an IMSI, PUK, and phone number (subscriber information) from the SIM card via a SIM card reader, and an IMEI (a client device identifier) from cell phone 1502. Bill stores the IMSI, PUK, phone number, IMEI, and “Johnphone,” in database device 1508.

Bill installs the SIM card in John's phone and returns John's cell phone 1502 to John. Later, upon realizing that he has forgotten to store the administrator code in cell phone 1502, Bill sends the PUK and the administrator code to cell phone 1502 via a wired communication link. Cell phone 1502 verifies that the administrator code is from Bill by authenticating the PUK, and stores the administrator code in a secure memory location within cell phone 1502 (e.g., a memory location inaccessible to John).

Assume that a number of weeks pass, and John calls Bill to explain that John has lost cell phone 1502 and that cell phone 1502's personal identification number (PIN) protection feature is turned off. As used herein, the term “PIN protection feature” may refer to a cell phone's security feature, when turned on, may require a user to input the PIN before the cell phone can be used with the SIM card. Because the PIN protection feature on cell phone 1502 is turned off, whoever finds cell phone 1502 may access John's subscription information in the SIM card.

Bill decides to try to turn on the PIN protection in John's cell phone 1502. At laptop 1504, via a user interface, Bill inputs a specific command (e.g., “turn on PIN protection”) that is to be sent to cell phone 1502 Laptop 1504 formats the command in canonical XML syntax.

As shown in FIG. 15, laptop 1504 contacts database device 1508, sending the phone number associated with the SIM card and the IMEI of cell phone 1502. Laptop 1504 receives the IMSI and the administrator code from database device 1508.

When laptop 1504 receives the subscriber information from database device 1508, laptop 1504 creates data block 804, generates a key, and uses the key to generate a signature block 806. In addition, laptop 1504 combines data block 804 and signature block 806 to produce a secure push message. Subsequently, as illustrated in FIG. 15, laptop 1504 sends the secure push message to cell phone 1502 via GSM/UMTS 1506.

As further illustrated in FIG. 15, cell phone 1502 receives the secure push message from laptop 1504. Secure push message client 404 in cell phone 1502 constructs a key, and validates the secure push message. In addition, secure push message client 404 validates the values for nonce field 814/time field 816 in the secure push message and stores the values in client device 102.

Secure push message client 404 scans the XML-formatted command in data field 822, and turns on the PIN protection feature in cell phone 1502 to prevent an unauthorized access to information in the SIM card within cell phone 1502.

### Conclusion

The foregoing description of implementations provides illustration, but is not intended to be exhaustive or to limit the implementations to the precise form disclosed. Modifications and variations are possible in light of the above teachings or may be acquired from practice of the teachings.

In the above, while a series of blocks has been described with regard to the exemplary processes illustrated in FIGS. 9, 11, 13 and 14, the order of the blocks may be modified in other implementations. In addition, non-dependent blocks may represent acts that can be performed in parallel to other blocks.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

It should be emphasized that the term “comprises/comprising” when used in this specification is taken to specify the presence of stated features, integers, steps or components but does not preclude the presence or addition of one or more other features, integers, steps, components, or groups thereof.

Further, certain portions of the implementations have been described as “logic” that performs one or more functions. This logic may include hardware, such as a processor, a microprocessor, an application specific integrated circuit, or a field programmable gate array, software, or a combination of hardware and software.

Even though particular combinations of features are recited in the claims and/or disclosed in the specification, these combinations are not intended to limit the invention. In fact, many of these features may be combined in ways not specifically recited in the claims and/or disclosed in the specification.

No element, act, or instruction used in the present application should be construed as critical or essential to the implementations described herein unless explicitly described as such. Also, as used herein, the article “a” is intended to include one or more items. Where one item is intended, the term “one” or similar language is used. Further, the phrase “based on” is intended to mean “based, at least in part, on” unless explicitly stated otherwise.

What is claimed is:

1. A method comprising:
receiving a secure push message from an administrator device;
generating a first key by combining an administrator code, a client device identifier that identifies a client device, and subscriber information that is associated with a service to which a user subscribes;
hashing the first key to generate a second key;
using the second key to sign a data block within the secure push message to produce an electronic signature; and
validating the secure push message based on the electronic signature.

2. The method of claim 1, further comprising:
obtaining, from the secure push message, parameters that are to be set within the client device.

3. The method of claim 2, where obtaining the parameters includes:
obtaining an extensible markup language data from within the secure push message.

4. The method of claim 1, further comprising:
comparing a nonce included in the secure push message to nonces that are stored in the client device to determine whether the secure push message is associated with a replay attack.

5. The method of claim 1, where receiving the secure push message includes:
receiving the secure push message in accordance with a wireless application protocol (WAP).

6. The method of claim 1, further comprising:
receiving the administrator code from the administrator device; and
enabling the client device to receive secure push messages, including at least one of:
authenticating a personal unblocking code (PUK); or
storing the administrator code in the client device when the PUK is successfully authenticated.

7. The method of claim 6, where authenticating a PUK includes:
comparing the PUK received from the administrator device to a PUK obtained from a removable memory of the client device.

8. The method of claim 1, further comprising:
performing a task in accordance with a command included in the secure push message.

9. The method of claim 8, where further comprising:
sending a reply to the administrator device to indicate the task is successfully performed.

10. The method of claim 1, where validating the secure push message includes:
comparing the electronic signature to an electronic signature that is included in the secure push message.

11. A device comprising:
a removable memory that includes subscriber information; and
a processor to:
receive a secure push message from a first device;
retrieve the subscriber information from the removable memory;
combine a first code associated with the first device, a client device identifier, and the subscriber information to obtain a first value;
hash the first value to produce a key;
use the key and a portion of the secure push message to generate an electronic signature; and
authenticate the secure push message by comparing the electronic signature to an electronic signature included in the secure push message.

12. The device of claim 11, wherein the device comprises:
a cell phone;
a personal computer; or
a portable digital assistant.

13. The device of claim 11, where the removable memory includes:
a subscriber information module (SIM) card.

14. The device of claim 11, where the processor is further configured to:
send a reply to the administrator device when the secure push message is successfully authenticated.

15. The device of claim 14, where the reply includes:
a nonce that is included in the secure push message.

16. The device of claim 11, where the client device identifier includes:
an International Mobile Equipment Identity (IMEI).

17. The device of claim 11, where the subscriber information includes at least one of:
a phone number;
a personal unblocking code (PUK); or
an international mobile subscriber identity (IMSI).

18. The device of claim 11, where the processor is further configured to:
compare a nonce in the secure push message to nonces that are stored in the device to determine whether the secure push message is associated with an attack.

19. The device of claim 11, where the secure push message includes at least one of:
data;
an electronic signature that is created by signing a portion of the secure push message;
a random number;
a timestamp; or
a data type value for indicating a format of data that is included in the secure push message.

20. A device comprising:
means for formatting a command;
means for combining the administrator code, a client device identifier that is associated with a client device, and subscriber information that is associated with a service to which a user subscribes, to produce a first key;
means for using the first key and the command to generate an electronic signature;
means for combining the electronic signature and the formatted command to produce a secure push message; and
means for sending the secure push message to the client device.
